(19) United States
(12) Patent Application Publication
(10) Pub. No.: US 2025/0142679 A1
(43) Pub. Date: May 1, 2025

(54) ATOMIZER

(71) Applicant: SHENZHEN WOODY VAPES TECHNOLOGY CO., LTD., Shenzhen (CN)

(72) Inventors: Jie CHEN, Shenzhen (CN); Zhenlong LIAO, Shenzhen (CN)

(73) Assignee: SHENZHEN WOODY VAPES TECHNOLOGY CO., LTD., Shenzhen (CN)

(21) Appl. No.: 18/798,033

(22) Filed: Aug. 8, 2024

(30) Foreign Application Priority Data
Oct. 27, 2023 (CN) 202311417871.9

(51) Int. Cl. H05B 6/10; H05B 6/44

(52) U.S. Cl. CPC H05B 6/10; H05B 6/44

(57) ABSTRACT

An atomizer is provided. The atomizer includes multiple heating assemblies. Each of the multiple heating assemblies includes a heating sleeve, a magnetic conductive member, and a magnet exciting coil. The magnetic conductive member includes an induction portion and two output portions. The two output portions are disposed at two ends of the induction portion. The magnet exciting coil is disposed on the induction portion. One end of each of the two output portions away from the induction portion faces the heating sleeve in a radial direction of the heating sleeve. Heating sleeves of the multiple heating assemblies are sequentially arranged in an axial direction of the heating sleeve. At least two induction portions of multiple induction portions have different widths in the axial direction of the heating sleeve.

### CROSS-REFERENCE TO RELATED APPLICATION

This application claims priority under 35 U.S.C. § 119 (a) to Chinese Patent Application No. 202311417871.9, filed Oct. 27, 2023, the entire disclosure of which is incorporated herein by reference.

### TECHNICAL FIELD

This disclosure relates to the field of atomizer technology, and in particular to an atomizer.

### BACKGROUND

Atomizers are used for vaporizing liquids or subliming solids to produce gases. In a process of producing gases, substances to-be-atomized need to be heated. When the substances to-be-atomized are heated, even heating needs to be ensured to avoid local overheating. The local overheating may cause chemical reactions in the substances heated, such as cracking or oxidation, resulting in denaturation of the substances heated, so that the final vapor loses original properties, and the desired effect cannot be achieved. In the related art, a single heat source is generally adopted to heat the substances to-to-atomized. When a large atomization speed is required, local overheating is easily caused, so that the substances to-be-atomized are denatured.

### SUMMARY

An atomizer is provided in embodiments of the present disclosure. The atomizer includes multiple heating assemblies. Each of the multiple heating assemblies includes a heating sleeve, a magnetic conductive member, and a magnet exciting coil. The magnetic conductive member includes an induction portion and two output portions. The two output portions are disposed at two ends of the induction portion. The magnet exciting coil is disposed on the induction portion. One end of each of the two output portions away from the induction portion faces the heating sleeve in a radial direction of the heating sleeve. Heating sleeves of the multiple heating assemblies are sequentially arranged in an axial direction of the heating sleeve. At least two induction portions of multiple induction portions have different widths in the axial direction of the heating sleeve.

### BRIEF DESCRIPTION OF THE DRAWINGS

To describe technical solutions in embodiments of the present disclosure more clearly, the following briefly introduces the accompanying drawings required for describing the embodiments. Obviously, the accompanying drawings in the following description show merely some embodiments of the present disclosure, and those skilled in the art may still obtain other drawings from these accompanying drawings without creative efforts.

In order to understand the present disclosure and the beneficial effects of the present disclosure more completely, the following description will be made with the accompanying drawings, in which like reference numerals represent like parts throughout the following descriptions.

FIG. 1 is a schematic cross-sectional structural view of an atomizer provided in an embodiment of the present disclosure.

FIG. 2 is a schematic structural view of multiple heating assemblies according to the embodiment in FIG. 1.

FIG. 3 is a schematic structural view of multiple magnetic conductive members according to the embodiment in FIG. 1.

FIG. 4 is a schematic structural view of multiple magnet exciting coils connected in series according to the embodiment in FIG. 1.

FIG. 5 is a schematic structural view of multiple heating sleeves and a thermal insulation ring according to the embodiment in FIG. 1.

Description of reference signs of the accompanying drawings:

| Reference | | Reference | |
|---|---|---|---|
| sign | Name | sign | Name |
| 10 | Heating assembly | 13 | Magnet exciting coil |
| 11 | Heating sleeve | 20 | Printed circuit board |
| | | | (PCB) |
| 12 | Magnetic conductive | 30 | Battery |
| | member | | |
| 12a | Output portion | 40 | Substance to-be- |
| | | | heated |
| 12b | Induction portion | 50 | Thermal insulation |
| | | | ring |
| 60 | Alternating current | | |
| | (AC) generator | | |

### DETAILED DESCRIPTION

Technical solutions of embodiments of the present disclosure will be described clearly and completely with reference to the accompanying drawings in the embodiments of the present disclosure. Obviously, the embodiments described herein are merely some embodiments, rather than all embodiments, of the present disclosure. All other embodiments obtained based on the embodiments described herein by those skilled in the art without creative efforts shall fall within the protection scope of the present disclosure.

An atomizer is provided in an embodiment of the present disclosure, so as to solve the problem that local overheating of a substance to-be-atomized is easily caused when a large atomization speed is required in an existing atomizer. Description will be given below with reference to the accompanying drawings.

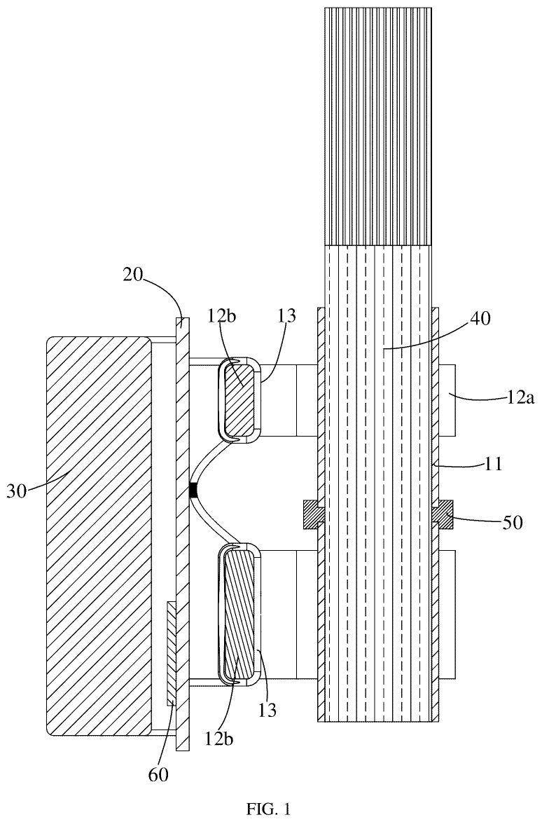

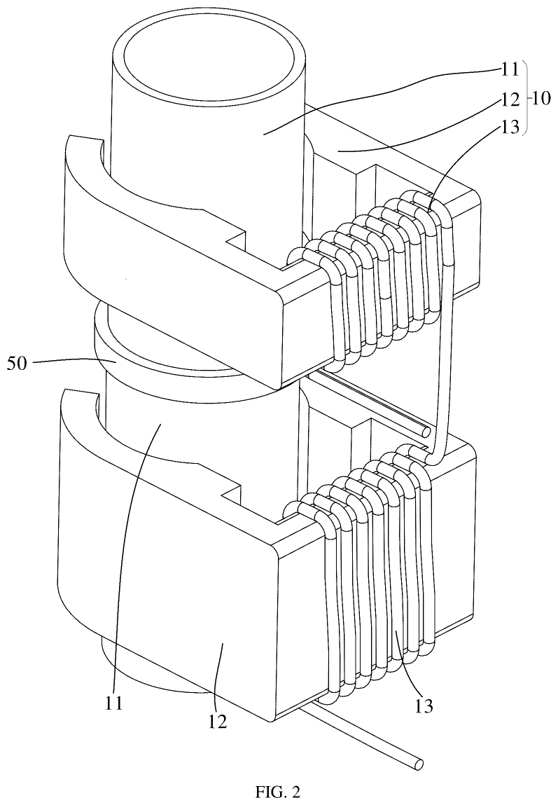

Referring to FIG. 1, an atomizer is provided in an embodiment of the present disclosure. FIG. 1 is a schematic cross-sectional structural view of an atomizer provided in an embodiment of the present disclosure. Reference can be made to FIG. 2, which is a schematic structural view of multiple heating assemblies according to the embodiment in FIG. 1. For example, the atomizer provided in the present disclosure includes multiple heating assemblies 10. Each heating assembly 10 includes a heating sleeve 11, a magnetic conductive member 12, and a magnet exciting coil 13. The magnetic conductive member 12 includes an induction portion 12b and two output portions 12a. The two output portions 12a are disposed at two ends of the induction portion 12b. The magnet exciting coil 13 is disposed on the induction portion 12b. One end of each of the two output portions 12a away from the induction portion 12b faces the heating sleeve 11 in a radial direction of the heating sleeve 11. Heating sleeves 11 of the multiple heating assemblies 10 are sequentially arranged in an axial direction of the heating sleeve 11. At least two of multiple induction portions 12b have different widths in the axial direction of the heating sleeve 11.

In the atomizer provided in embodiments of the present disclosure, the at least two of the multiple induction portions of the multiple magnetic conductive members have different widths in the axial direction of the heating sleeve, so that when the same current is applied to the magnet exciting coils, magnetic field fluxes of induced magnetic fields generated by the induction portions with different widths are also different. According to Lenz's law, an induced electromotive force is equal to the rate of change of the magnetic field flux with time, so that the induced electromotive force outputted to the heating sleeve by the induction portion having a small magnetic field flux is also small, and thus the thermal efficiency of an eddy current generated on the heating sleeve is also low. As a result, the heating assemblies corresponding to the induction portions with different widths have different thermal efficiencies. When different heating assemblies heat a substance to-be-heated, different parts of the substance to-be-heated have different temperatures due to a thermal convection effect. Therefore, different parts of the substance to-be-heated cannot be heated with the same thermal efficiency, otherwise the part of the substance to-be-heated having a higher temperature will be overheated. With the atomizer provided in the embodiments of the present disclosure, at least two heating assemblies can heat with different powers, thereby avoiding local overheating. In addition, since multiple heating assemblies are adopted, large heating efficiency can be ensured. In conclusion, the atomizer provided in the embodiments of the present disclosure can ensure that the substance to-be-atomized will not be locally overheated when a large atomization speed is achieved.

A current of changing intensity is generally applied to the magnet exciting coil 13, to generate a magnetic field of intensity changing with time in the coil. This magnetic field can serve as an excitation magnetic field. The magnetic conductive member 12 is generally made of a ferromagnetic medium, so that the excitation magnetic field can excite the induction portion 12b of the magnetic conductive member 12 to generate an induced magnetic field. In addition, since the magnetic conductive member 12 is made of a ferromagnetic medium, the induced magnetic field and the excitation magnetic field can be conducted by the magnetic conductive member 12, and are output to the heating sleeve 11 through the end of the output portion 12a away from the induction portion 12b. Since the intensity of the excitation magnetic field changes with time, both the magnetic field of the induced magnetic field and the magnetic field of the excitation magnetic field change with time. Therefore, when the changing magnetic field is input to the heating sleeve 11, there will be a vertex electric field on a sidewall of the heating sleeve 11, thereby generating an eddy current, further generating a thermal effect of the current, and starting to heat the substance to-be-heated 40.

A magnitude of an induced electromotive force generating a vertex electric field can be calculated by Lenz's law, that is, the magnitude of the induced electromotive force is equal to the rate of change of the magnetic field of the excitation magnetic field and the magnetic field the induced magnetic field with respect to time. It can be seen that the rate of change of the flux of the magnetic field with respect to time ultimately determines the thermal efficiency. In addition, it can be seen that according to the principle of electromagnetism, when the currents having identical intensities are applied to the coils and the magnet exciting coils 13 have identical turns densities, the intensities of the excitation magnetic fields are identical. The width of the induction portion 12b in the axial direction of the heating sleeve 11 changes, so that the cross-sectional area of the induction portion 12b in a direction of number of turns changes. In this way, when the turns densities of the magnet exciting coils 13 are identical and identical currents are applied to the magnet exciting coils 13, magnetic fluxes output to the heating sleeves 11 by the magnetic conductive members 12 corresponding to the induction portions 12b with different widths are different, so that the thermal efficiencies of the corresponding heating assemblies 10 are different. In other words, the thermal efficiency of the corresponding heating assembly 10 can be controlled by controlling the widths of the induction portions 12b in the axial direction of the heating sleeve 11. It can be seen that the atomizer provided in the embodiments of the present disclosure can provide various thermal efficiencies, thereby achieving even heating, and preventing the local temperature of the substance to-be-heated 40 from being too high.

In addition, the thermal efficiency is controlled by the width of the induction portion 12b, so that there is no need to set up a power supply and a controller for each coil separately, thereby simplifying thermal efficiency control and reducing the cost.

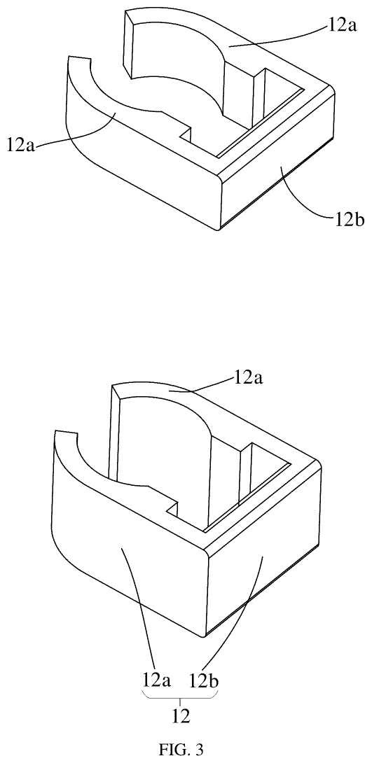

Referring to FIG. 2 or FIG. 3, the output portion 12a may be an arm that is not wound with the magnet exciting coil 13 as illustrated in FIG. 2 or FIG. 3. However, it is also not excluded that in other embodiments of the present disclosure, the output portion 12a is still wound with the magnet exciting coil 13, because a medium having magnetic conductivity is generally ferromagnetic as well, and can be used for generating an induced magnetic field.

Referring to FIG. 2, it can be seen that in some embodiments of the present disclosure, one end of the output portion 12a away from the induction portion 12b faces the heating sleeve 11 in the radial direction of the heating sleeve 11. Therefore, the induced magnetic field and the excitation magnetic field can be transmitted to the heating sleeve 11 as many times as possible, thereby avoiding the loss of magnetic field energy.

Referring to FIG. 1, the substance to-be-heated 40 is placed in a heating sleeve 11 and heated, and the substance to-be-heated 40 may be in a solid state or a liquid state. When the substance to-be-heated 40 is in a solid state, the substance to-be-heated 40 may be in direct contact with the heating sleeve 11. When the substance to-be-heated 40 is in a liquid state, a sealing sleeve may be disposed inside each heating sleeve 11 to store the substance to-be-heated 40 in a liquid state. Alternatively, the heating sleeves 11 may be directly sealed to each other to define a liquid storage chamber.

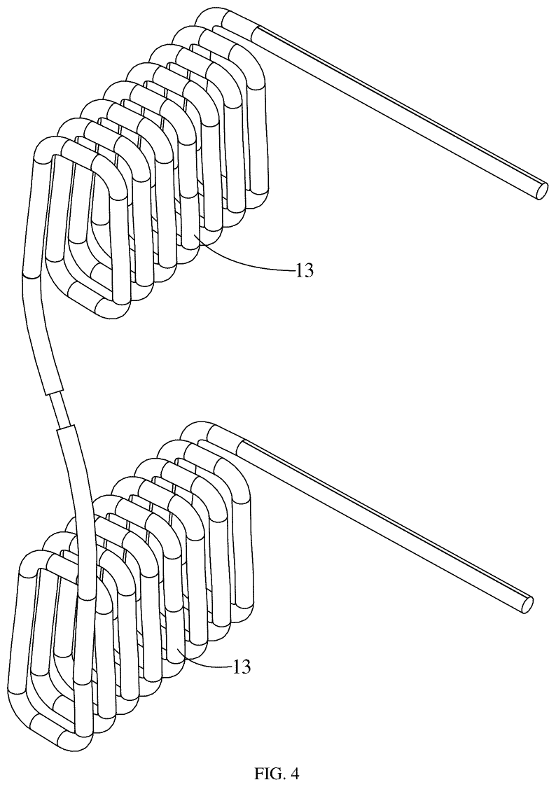

Referring to FIG. 4, multiple magnet exciting coils 13 are sequentially connected in series. The impedance of the magnet exciting coils 13 has a certain voltage drop effect on the alternating current (AC) (similar to a voltage drop effect of a resistor on the direct current (DC)). The magnet exciting coils 13 are connected in series to each other, so that when the current of changing intensity is applied, the voltage drops to a certain level each time the current of changing intensity passes through one coil. In addition, the impedance of the magnet exciting coil 13 is positively correlated with the back electromotive force of both the excitation magnetic field and the induced magnetic field of the magnet exciting coil 13 across the magnet exciting coil 13. Since the back electromotive force can also be calculated by Lenz's law, the serial connection of the coils allows the exciting coil 13 corresponding to the induction portion 12b having a larger width to receive a higher voltage, thereby achieving higher thermal efficiency. Therefore, the heat efficiency at a position where high thermal efficiency is required (that is, a position corresponding to a heating sleeve 11 of the heating assembly 10 including the induction portion 12b having a large width) is higher, which is beneficial to controlling the thermal efficiency.

Referring to FIG. 1, in some embodiments of the present disclosure, the atomizer further includes a printed circuit board (PCB) 20. A joint between adjacent magnet exciting coils 13 are welded with the PCB 20. The PCB 20 can diversify the electrical connection of the magnet exciting coils 13. Since there are many circuit structures on the PCB 20, switching between parallel connection of the magnet exciting coils 13 and series connection of the magnet exciting coils 13 can be implemented. When the parallel connection is adopted, voltages distributed to different magnet exciting coils 13 may be configured by a variable resistance circuit, thereby more precisely controlling the thermal efficiency. It is also not excluded that the welding of the magnet exciting coil 13 and the PCB 20 may only be used for fixing and limiting, and does not realize electrical connection. In addition, the atomizer may further include a battery 30. The battery 30 is electrically connected to the PCB 20 to supply power to the magnet exciting coil. An AC generator 60 may further be disposed on the PCB 20 to convert a DC generated by the battery 30 into an AC, so as to provide an AC for the magnet exciting coil 13. With arrangement of the battery 30, the atomizer does not require a fixed power supply and is convenient to move or carry around.

Referring to FIG. 1, in some embodiments of the present disclosure, the heating assembly 10 has a vapor output direction in the axial direction of the heating sleeve 11. In the vapor output direction, widths of the multiple induction portions 12b decrease one by one. These embodiments are very effective when the substance to-be-heated 40 is in a solid state. When the substance to-be-heated 40 is in a solid state, heated gas will be mixed with the substance to-be-heated 40, thus the substance to-be-heated 40 downstream of the heated gas is heated, and the heated gas moves in the vapor output direction. Therefore, in the vapor output direction, the temperature of the substance to-be-heated 40 gradually increases after being heated by the heated gas. When the substance having a higher temperature is heated, a smaller heating power is required, to ensure that the substance to-be-heated 40 can be atomized and the substance to-be-heated 40 will not be overheated and denatured. In addition, this arrangement is equally effective for liquid, but for different reasons. As long as the liquid does not boil, vaporization of the liquid often occurs at a gas-liquid interface. However, since thermal convection exists inside the liquid (thermal convection also exists for the gas, and thus the gas generated when the solid is heated also convects, so that the substance to-be-heated 40 in the vapor output direction is heated by the gas under some conditions), the thermal efficiency still needs to be reduced in the vapor output direction. However, in the present disclosure, it cannot be considered that there is only the embodiment where the thermal efficiency decreases in the vapor output direction, because there is also a possible situation where the thermal efficiency increases in the vapor output direction. For example, when the substance to-be-heated 40 has a large size in the radial direction of the heating sleeve 11, and the heat cannot easily enter the central position of the substance to-be-heated 40, it is impossible to vaporize the substance to-be-heated 40 at the bottom of the heating assembly 10 opposite to the vapor output direction in one go. As a result, the central position of the object to-be-heated 40 cannot be heated through heat transmission. Meanwhile, since an outer part of the substance to-be-heated 40 is vaporized, a large quantity of heat is absorbed, leading to the failure of vaporization of the central position of the substance to-be-heated 40. In this case, in order to evenly heat, a heating assembly 10 with a small heating power needs to be disposed at the bottom of the atomizer in a direction opposite to the vapor output direction, and the heating efficiency is gradually increased in the vapor output direction, so as to adapt to the substance to-be-heated 40 whose temperature gradually increases, thereby achieving the effect of even heating.

Referring to FIG. 1 or FIG. 2, description is now given to the vapor output direction. For some atomizers that naturally output vapor, such as some air humidifiers, the vapor output direction is usually opposite to the gravity direction and is along the axial direction of the heating sleeve 11. In addition, there are some atomizers having negative pressure, such as an atomizer used in inhalation therapy in the hospital, so that the vapor output direction is independent of the gravity direction, but is a direction of the pressure decrease. For the atomizer having negative pressure, the atomization direction is also usually along the axial direction of the heating sleeve 11.

Referring to FIG. 1 or FIG. 2, in some embodiments of the present disclosure, adjacent magnetic conductive members 12 are spaced apart from each other. Since a position of the heating sleeve 11 which is heated to the highest degree is a position of the heating sleeve 11 facing the output portion 12a of the magnetic conductive member 12, the adjacent magnetic conductive members 12 are spaced apart from each other. Therefore, the heat of the heating sleeve 11 is less likely to be transmitted to the adjacent heating sleeves 11, thereby improving the accuracy of thermal efficiency control.

Referring to FIG. 2, in some embodiments of the present disclosure, an end surface of one end of the output portion 12a facing the heating sleeve 11 matches a surface of the heating sleeve 11. Therefore, the volume of an air gap defined between the end surface of the output portion 12a facing the heating sleeve 11 and the heating sleeve 11 is reduced, so that magnetism leakage at the air gap is avoided, the utilization rate of magnetic energy is improved, and further the atomizer is more energy-efficient.

Referring to FIG. 4, in some embodiments of the present disclosure, the multiple magnet exciting coils 13 have identical coil turns densities. According to the principle of electromagnetism, it can be seen that the intensity of the magnetic field generated inside the magnet exciting coil 13, that is, the intensity of the excitation magnetic field, is directly proportional to the product of the coil turns density and the intensity of the current in the coils. When the different magnet exciting coils 13 have identical coil turns densities, and the identical current is applied to the different magnet exciting coils 13, the different magnet exciting coils 13 have identical intensity of the excitation magnetic fields. Therefore, the heating efficiency is only related to the width of the induction portion 12b in the axial direction of the heating sleeve 11, so that the control of the thermal efficiency is more convenient.

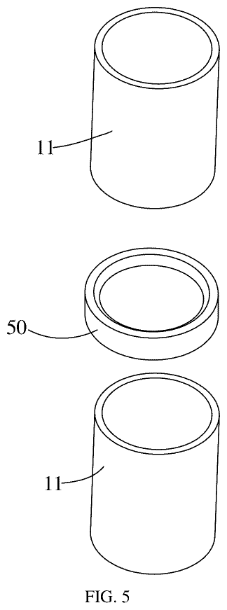

Referring to FIG. 1 and FIG. 5, in some embodiments of the present disclosure, the atomizer further includes a thermal insulation ring 50. The thermal insulation ring 50 is disposed between adjacent heating sleeves 11. Therefore, the heat transfer between the adjacent heating sleeves 11 can be avoided, so that the control of the heating efficiency is more accurate.

Referring to FIG. 5, in some embodiments of the present disclosure, the heating sleeve 11 is cylindrical. Since the cylindrical heating sleeve 11 has axial revolution symmetry, a distance from any point on an axis of the substance to-be-heated 40 to an inner wall of the heating sleeve 11 is equal, which facilitates even heat transmission to the center of the substance to-be-heated 40 and makes heating evener.

Referring to FIG. 5, optionally, cylinder walls of the multiple heating sleeves 11 have identical thicknesses. Since the eddy current flows in an extending direction of the cylinder wall of the heating sleeve 11, if the cylinder wall is thicker, the cross-sectional area of the cylinder wall in the cross-section perpendicular to the flowing direction of the eddy current will be larger, and the resistance of the cylinder wall to the eddy current will be smaller. It is sufficient to see that the thickness of the cylinder wall will affect the thermal efficiency. Therefore, the cylinder walls of the heating sleeves 11 have identical thicknesses, so that the influence of the cylinder wall on the heating efficiency can be eliminated, and the control of the heating efficiency is more convenient.

In the above embodiments, the description of each embodiment has its own emphasis. For the parts not described in detail in one embodiment, reference may be made to related descriptions in other embodiments.

In the description of the present disclosure, terms such as “first” and “second” are used herein for purposes of description and are not intended to indicate or imply relative importance or to imply the number of indicated technical features. Thus, the feature defined with “first” and “second” may explicitly or implicitly include one or more of such a feature.

The atomizer provided in the embodiments of the present disclosure is described in detail in the foregoing. Specific examples are used in this description to describe principles and implementations of the present disclosure. The description of the above embodiments is merely used to help understand the method and the core idea of the present disclosure. Meanwhile, for those skilled in the art, there may be changes in the specific implementations and application scopes according to the idea of the present disclosure. In conclusion, the content of the specification shall not be construed as a limitation to the present disclosure.

What is claimed is:

1. An atomizer comprising a plurality of heating assemblies, wherein each of the plurality of heating assemblies comprises a heating sleeve, a magnetic conductive member, and a magnet exciting coil;
the magnetic conductive member comprises an induction portion and two output portions, and the two output portions are disposed at two ends of the induction portion; and the magnet exciting coil is disposed on the induction portion, and one end of each of the two output portions away from the induction portion faces the heating sleeve in a radial direction of the heating sleeve; and
heating sleeves of the plurality of heating assemblies are sequentially arranged in an axial direction of the heating sleeve, and at least two of a plurality of induction portions have different widths in the axial direction of the heating sleeve.

2. The atomizer of claim 1, wherein a plurality of magnet exciting coils are sequentially connected in series.

3. The atomizer of claim 2, further comprising a printed circuit board (PCB), wherein a joint between adjacent magnet exciting coils of the plurality of magnet exciting coils are welded with the PCB.

4. The atomizer of claim 1, wherein each of the plurality of heating assemblies has a vapor output direction in the axial direction of the heating sleeve, and in the vapor output direction, widths of the plurality of induction portions decrease one by one.

5. The atomizer of claim 1, wherein adjacent magnetic conductive members are spaced apart from each other.

6. The atomizer of claim 1, wherein an end surface of one end of each of the two output portions facing the heating sleeve matches a surface of the heating sleeve.

7. The atomizer of claim 1, wherein a plurality of magnet exciting coils have identical coil turns densities.

8. The atomizer of claim 1 further comprising a thermal insulation ring, wherein the thermal insulation ring is disposed between adjacent heating sleeves.

9. The atomizer of claim 1, wherein the heating sleeve is cylindrical.

10. The atomizer of claim 9, wherein cylinder walls of a plurality of heating sleeves have identical thicknesses.

11. The atomizer of claim 3, further comprising a battery, wherein the battery is electrically connected to the PCB, and is configured to supply power to a plurality of magnet exciting coils.

12. The atomizer of claim 11, wherein an alternating current (AC) generator is further disposed on the PCB, and is configured to convert a direct current (DC) generated by the battery into an AC.
